(19) United States
(12) Patent Application Publication
(10) Pub. No.: US 2022/0315060 A1
(43) Pub. Date: Oct. 6, 2022

(54) TAXI SYSTEM

(71) Applicant: TOYOTA JIDOSHA KABUSHIKI KAISHA, Toyota-shi (JP)

(72) Inventors: Makoto KAKUCHI, Toyota-shi (JP); Osamu IZUMIDA, Nagoya-shi (JP); Shunji INOUE, Okazaki-shi (JP); Takumi HAMAJIMA, Takatsuki-shi (JP); Mitsushi KINTAKA, Kariya-shi (JP); Toshihiro ANDOU, Kariya-shi (JP); Masamitsu TAKAHIRA, Kariya-shi (JP)

(21) Appl. No.: 17/658,170

(22) Filed: Apr. 6, 2022

(30) Foreign Application Priority Data
Apr. 6, 2021 (JP) 2021-064814

(51) Int. Cl. B60W 60/00; B60W 40/06; B60W 40/04; G08G 1/00

(52) U.S. Cl. CPC B60W 60/00253; B60W 60/0016; B60W 40/06; B60W 40/04; G08G 1/22; G08G 1/20; B60W 2552/00; B60W 2420/42; B60W 2420/52; B60W 2420/54

(57) ABSTRACT

A taxi system includes: a plurality of taxi vehicles that each transport a user to a destination by automatic driving; and a management center, in which the management center, when a prescribed protection condition is satisfied, instructs one or more unmanned taxi vehicles to execute the protection traveling that is traveling while protecting a manned taxi group including one or more manned taxi vehicles, and the unmanned taxi vehicle, when having received an execution instruction of the protection traveling, protects the manned taxi group by traveling adjacently to the manned taxi group in a front-rear direction.

### CROSS REFERENCE TO RELATED APPLICATION

This application claims priority to Japanese Patent Application No. 2021-064814 filed on Apr. 6, 2021, which is incorporated herein by reference in its entirety including the specification, claims, drawings, and abstract.

### TECHNICAL FIELD

The present specification discloses a taxi system including a plurality of taxi vehicles that each transport a user to a destination, in a state where no driver rides therein, by automatic driving.

### BACKGROUND

In recent years, it has been proposed to use a self-driving vehicle capable of automatic driving as a taxi vehicle. For example, PATENT LITERATURE 1 discloses a technique to provide a taxi service using a self-driving vehicle. In PATENT LITERATURE 1, when traveling by automatic driving is disabled due to an unexpected situation, driving of a taxi vehicle is conducted by a remote operation.

### CITATION LIST

PATENT LITERATURE 1: JP 2017-174208 A

Meanwhile, in the case of a taxi vehicle that uses automatic driving, naturally, no driver rides therein, and the taxi vehicle can be considered to be an unmanned vehicle as long as a taxi user rides therein (in other words, out of in-use). Conventionally, such an unmanned taxi vehicle travels independently without being in cooperation with a manned taxi vehicle in which a user rides. In other words, conventionally, using the unmanned taxi vehicle in order to increase the safety of the manned taxi vehicle has not been examined. Therefore, in the related art, there has been room for further improvement in terms of increased safety of an occupant in the taxi vehicle.

Therefore, the present specification discloses a taxi system that can further increase the safety of a user.

### SUMMARY

The present specification discloses a taxi system including: a plurality of taxi vehicles that each transport a user to a destination, in a state where no driver rides therein, by automatic driving; and a management device that manages the plurality of the taxi vehicles, in which the management device divides and manages the plurality of the taxi vehicles into one or more manned taxi vehicles in which the user rides and one or more unmanned taxi vehicles in which the user does not ride, the management device, when a prescribed protection condition is satisfied, instructs the one or more unmanned taxi vehicles to execute protection traveling that is traveling while protecting a manned taxi group including the one or more manned taxi vehicles, and the unmanned taxi vehicle, upon receipt of an execution instruction of the protection traveling, protects the manned taxi group by traveling adjacently to the manned taxi group in a front-rear direction or in a left-right direction.

With such the configuration, the unmanned taxi vehicle functions as a “shield” that protects the manned taxi vehicle, so that the safety of the user can be further increased.

In this case, the protection condition includes the unmanned taxi vehicle being present that satisfies an application possible condition in which the unmanned taxi vehicle is capable of reaching the manned taxi group within a defined protection reference time, and a traveling route of the unmanned taxi vehicle is at least partially overlapped with that of the manned taxi group, and the management device may, when an unmanned taxi vehicle that satisfies the application possible condition is present, instruct the unmanned taxi vehicle to execute the protection traveling.

With such a configuration, without changing a movement destination of the unmanned taxi vehicle, the unmanned taxi vehicle can be applied to the protection of the manned taxi vehicle. As a result, without lowering the usage efficiency of the taxi vehicle, the safety of the user can be increased.

Moreover, the protection condition includes a protection demand having been issued from a user of the manned taxi vehicle, and the management device may, upon receipt of the protection demand, instruct the unmanned taxi vehicle to which no task is set to execute the protection traveling.

With such a configuration, the safety of the user who desires high safety can be reliably increased.

Moreover, the protection condition includes a vulnerable person riding in the manned taxi vehicle, and the management device may, when the manned taxi vehicle in which the vulnerable person is riding is present, instruct the unmanned taxi vehicle to which no task is set to conduct the protection traveling.

With such the configuration, the vulnerable person who needs higher safety can be appropriately protected.

Moreover, the taxi vehicle includes a road surface sensor that detects a road surface state, and the unmanned taxi vehicle may, when traveling immediately in front of the manned taxi group for the protection traveling, transmit a detection result by the road surface sensor to the manned taxi group to be protected.

With such a configuration, the preceding unmanned taxi vehicle functions as an “outrider” of the succeeding manned taxi group, so that the safety of the manned taxi group can be further increased.

Moreover, the management device may determine a traveling position of the unmanned taxi vehicle when the protection traveling is executed, based on at least one among a relative positional relationship between the unmanned taxi vehicle and the manned taxi group before the protection traveling is started, presence or absence of a manual driving vehicle that travels adjacently to the manned taxi group in the front-rear direction before the protection traveling is started, and a position of the manned taxi vehicle in which a vulnerable person rides in the manned taxi group.

With such a configuration, the unmanned taxi vehicle can be arranged at a suitable position, so that the safety of the manned taxi group can be increased more reliably.

Moreover, the management device may, when the manned taxi group and the different manned taxi vehicle that does not belong to the manned taxi group are capable of merging with each other within a defined merge reference time, and a traveling route of the manned taxi group and a traveling route of the different manned taxi vehicle are at least partially overlapped with each other, instruct the manned taxi group and the different manned taxi vehicle to merge with each other.

With such a configuration, the manned taxi vehicles are positively gathered. As a result, the probability of an accident of the manned taxi vehicle can be reduced. Moreover, with such a configuration, the number of manned taxi groups in the whole taxi system, and as a result, the number of unmanned taxi vehicles that protect the manned taxi groups, can be suppressed to the small number.

Moreover, the management device manages respective traveling positions of the manned taxi vehicle, the unmanned taxi vehicle, and the manual driving vehicle in which a driver conducts a driving operation, and the management device may select with priority, when the manual driving vehicle and the manned taxi group are adjacent to each other in the front-rear direction, a position between the manual driving vehicle and the manned taxi group as a traveling position of the unmanned taxi vehicle that protects the manned taxi group.

Generally, the manual driving vehicle may perform unexpected behavior due to a human error and the like in some cases. The unmanned taxi vehicle is caused to cut in between such a manual driving vehicle and the manned taxi group, whereby the manned taxi vehicle can be appropriately protected from the manual driving vehicle.

The taxi system disclosed in the present specification can further increase the safety of the user of the manned taxi vehicle.

### BRIEF DESCRIPTION OF DRAWINGS

Embodiment(s) of the present disclosure will be described based on the following figures, wherein:

FIG. 1 is an image diagram illustrating a configuration of a taxi system;

FIG. 2 is a block diagram illustrating a configuration of a taxi vehicle;

FIG. 3 is a block diagram illustrating a configuration of a management center;

FIG. 4 is an image diagram illustrating a state of protection traveling;

FIG. 5 is another image diagram illustrating a state of the protection traveling;

FIG. 6 is a diagram for explaining an inter-vehicle distance between taxi vehicles when the protection traveling is executed;

FIG. 7 is a diagram illustrating one example of traveling routes of a manned taxi group and an unmanned taxi vehicle;

FIG. 8 is a diagram illustrating another example of the traveling routes of the manned taxi group and the unmanned taxi vehicle;

FIG. 9 is a diagram illustrating one example of a score table that is referred to when scores are calculated; and

FIG. 10 is an image diagram illustrating a state where the manned taxi group is formed.

### DESCRIPTION OF EMBODIMENTS

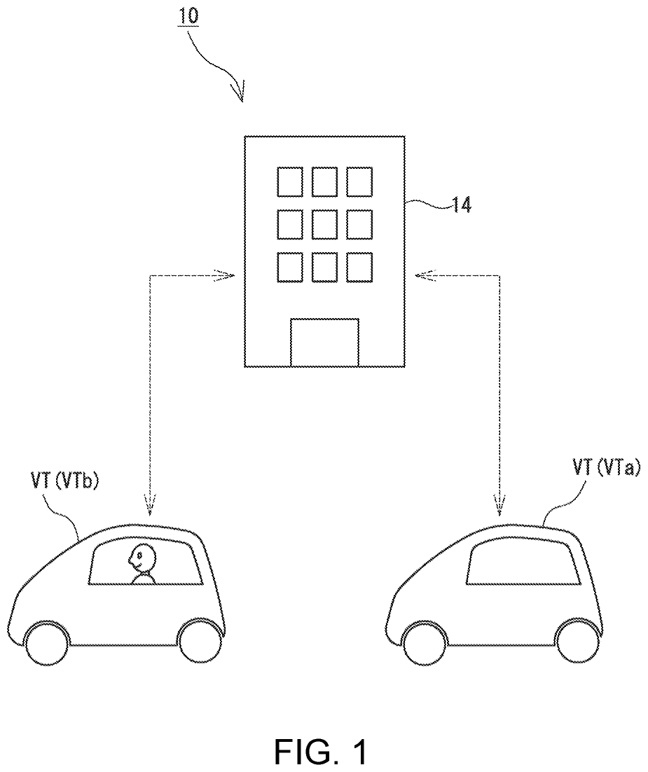

Hereinafter, a configuration of a taxi system 10 will be described with reference to the drawings. FIG. 1 is an image diagram illustrating a configuration of the taxi system 10. The taxi system 10 is provided with a plurality of taxi vehicles VT and a management center 14.

The taxi vehicle VT is a vehicle that receives a request from a user, and transports the user to a destination under an individual contract. The taxi vehicle VT in this example is a single-passenger vehicle with a seating capacity of one. Note that, naturally, an infant or the like is not counted as an occupant, and can ride with an adult. Moreover, the taxi vehicle VT is a self-driving vehicle in which all dynamic driving tasks are conducted by the vehicle. Accordingly, no driver rides in the taxi vehicle VT.

Here, “automatic driving” indicates that the vehicle conducts almost all dynamic driving tasks, and indicates, for example, any of levels 3 to 5 defined by the Society of Automotive Engineers in the USA. The level 3 is a driving mode in which all the dynamic driving tasks are automated in a specified location such as a superhighway, but an operation by a driver becomes necessary in case of emergency. Moreover, the level 4 is a driving mode in which all the dynamic driving tasks are automated only in a specified location, and measures in case of emergency are automatically processed. The level 5 is a driving mode in which automatic driving is possible under almost all the conditions without limitations of a location and the like, and indicates so-called “perfect automatic driving”.

The management center 14 divides and manages the plurality of the taxi vehicles VT into manned taxi vehicles VTb and unmanned taxi vehicles VTa. Note that hereinafter, when the manned taxi vehicle VTb and the unmanned taxi vehicle VTa are not distinguished from each other, both are simply referred to as “the taxi vehicle VT”. The manned taxi vehicle VTb indicates the taxi vehicle VT in which a user is riding. Normally, the manned taxi vehicle VTb is in a “in-use state” in which a user is transported to the destination based on an individual contract with the user. The unmanned taxi vehicle VTa indicates a taxi vehicle in which no user is riding. Normally, the unmanned taxi vehicle VTa is in any of an “empty state” in which the unmanned taxi vehicle VTa waits until a new usage contract is established, a “pick-up state” in which the unmanned taxi vehicle VTa moves to a user in a remote place, and an “out-of-service state” in which the unmanned taxi vehicle VTa moves to a prescribed out-of-service station for charging or the like. The management center 14 communicates with each of the plurality of the taxi vehicles VT, and thus grasp a traveling state (eventually, the presence or absence of a user) in each taxi vehicle VT and a position of each taxi vehicle VT.

Moreover, the management center 14 also manages allocation of the taxi vehicles VT, in addition to the state management of the taxi vehicles VT. Specifically, the management center 14 calculates desired arrangement of the taxi vehicles VT by considering a request from a user, distribution statuses of the taxi vehicles VT and persons in town, and the like, and outputs allocation instructions to the taxi vehicles VT. Moreover, the management center 14 instructs some of the unmanned taxi vehicles VTa to execute protection traveling in which the unmanned taxi vehicle VTa travels while protecting the manned taxi vehicle VTb, if necessary, which will be described later. The taxi vehicle VT travels in accordance with various kinds of instructions from the management center 14.

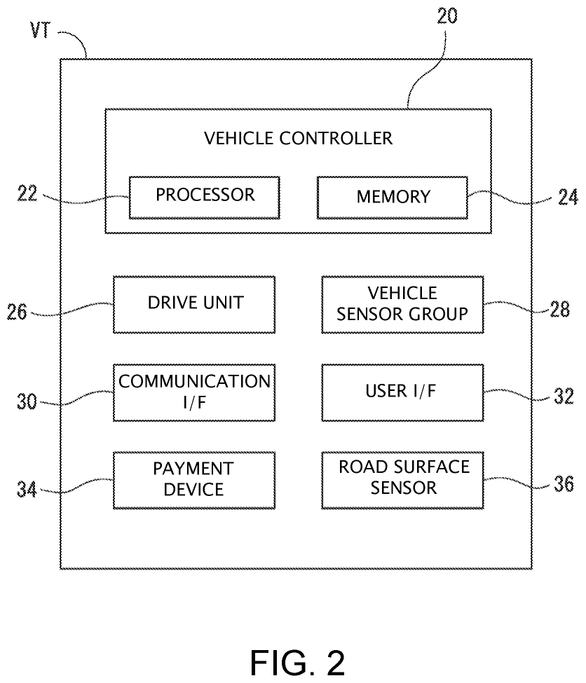

Next, configurations of the taxi vehicle VT and the management center 14 will be described. FIG. 2 is a block diagram illustrating a configuration of the taxi vehicle VT. A drive unit 26 is a device that generates a mechanical driving force for causing the taxi vehicle VT to travel, and includes a prime mover and a power transmission device, a brake device, a suspension device, and a steering device, for example. A vehicle sensor group 28 includes a plurality of sensors for sensing various kinds of information necessary for traveling of the taxi vehicle VT. Such a vehicle sensor group 28 includes, for example, a sensor (for example, a camera, an LiDAR, a millimeter-wave radar, or an ultrasound sensor) for detecting a surrounding environment of the taxi vehicle VT, a sensor (for example, a GPS) for detecting a current position of the taxi vehicle VT, or a sensor (for example, an acceleration sensor or a gyro sensor) for detecting a traveling state of the taxi vehicle VT. Information detected by the vehicle sensor group 28 is transmitted to a vehicle controller 20. The vehicle controller 20 computes an amount of acceleration and deceleration and a steering amount of the taxi vehicle VT based on the information detected by the vehicle sensor group 28, and drives the drive unit 26.

A communication I/F 30 communicates with an information device outside the vehicle using a communication technique. In this case, examples of information devices to be communicated include the management center 14, other taxi vehicles VT, and an information terminal owned by a user. Such communication may be performed using mobile data communication provided by a mobile telephone company, may be performed using near field communication such as Bluetooth (registered trademark), or may be performed using a dedicated communication channel.

A user I/F 32 is a device that presents information to a user, and receives an operation by the user. The user I/F 32 includes, for example, an output device that outputs information to the user, and an input device that receives an operation by the user. The output device may include, for example, at least one among a display, a speaker, and a lamp. Moreover, the input device may include, for example, at least one among a touch panel, a key board, a switch, a lever, a pedal, and a microphone.

A payment device 34 is a device that executes collection of a usage fare of the taxi vehicle VT alone or together with the management device. Accordingly, the payment device 34 may include a device for collecting usage fares, for example, a change machine that counts a money amount of dropped cash, and gives a user their change if necessary, a card reader that processes payment with a credit card, an RFID reader/writer that communicates with an IC chip built into a prepaid card, a bar code reader for executing bar code payment, and the like. Moreover, the payment device 34 may be a device that acquires access information (for example, identification information, a password, and the like of a user) for accessing an electronic wallet pre-registered by the user, and transmits the access information to the management center 14. In this case, the management center 14 accesses the electronic wallet of the user based on the received access information, and collects the usage fare.

A road surface sensor 36 is a sensor that detects a state of a road surface. Such a road surface sensor 36 may include, for example, at least one among a laser sensor that detects the thickness of each of layers of water, ice, and snow on a surface of the road surface in accordance with reflection by laser light, a non-contact temperature sensor that measures the temperature on the surface of the road surface in a non-contact manner, and a temperature-humidity sensor that measures the temperature and the humidity in an ambient atmosphere. By including such sensors, the road surface sensor 36 can determine whether the state of the road surface is any of a dry state, a wet state, a slushy state, a frozen state, and a snowfall state. Moreover, the road surface sensor 36 may include a vibration sensor that measures the vibration amount of the taxi vehicle VT. By including the vibration sensor, the road surface sensor 36 can detect an uneven state in the road surface. Moreover, the road surface sensor 36 may include a camera that images the road surface. By including the camera, the road surface sensor 36 can detect the type of pavement on the road surface, the presence or absence of foreign matter on the road, and the like. Information detected by the road surface sensor 36 is transmitted to the vehicle controller 20.

The vehicle controller 20 controls driving of the taxi vehicle VT. The vehicle controller 20 grasps a surrounding environment of the taxi vehicle VT, for example, from detection results by the vehicle sensor group 28, and controls driving of the drive unit 26 so as to allow the taxi vehicle VT to travel safely.

Such a vehicle controller 20 is physically a computer including a processor 22 and a memory 24. The “computer” includes a micro controller in which a computer system is incorporated into one integrated circuit. Moreover, the processor 22 indicates a processor in a broad sense, and includes a general processor (for example, CPU: Central Processing Unit), and a dedicated processor (for example, GPU: Graphics Processing Unit, ASIC: Application Specific Integrated Circuit, FPGA: Field Programmable Gate Array, and a programmable logic device). Moreover, the processor 22 does not need to be physically one element, but may include a plurality of processors that are present at positions that are physically distant from one another. Similarly, the memory 24 also does not need to be physically one element, but may include a plurality of memories that are present at positions that are physically distant from one another. Moreover, the memory 24 may include at least one among a semiconductor memory (for example, a RAM, a ROM, and a solid state drive) and a magnetic disk (for example, a hard disk drive).

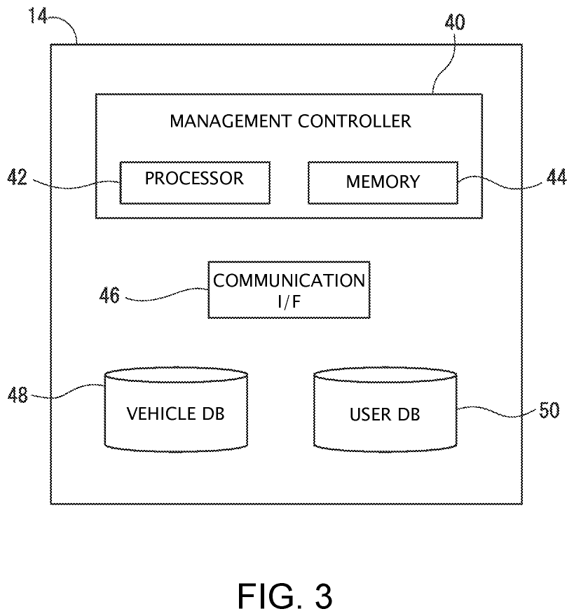

Next, a configuration of the management center 14 will be described. FIG. 3 is a block diagram illustrating a configuration of the management center 14. The management center 14 includes a management controller 40, a communication I/F 46, a vehicle DB 48, and a user DB 50. The communication I/F 46 communicates with the plurality of the taxi vehicles VT via a general communication network or a dedicated communication network. Moreover, the communication I/F 46 is capable of communicating with a vehicle other than the taxi vehicle VT, for example, a manual driving vehicle in which a driver conducts a driving operation, and can acquire a position of the manual driving vehicle through the communication.

The vehicle DB 48 is a database in which information on the plurality of the taxi vehicles VT included in the taxi system 10 is recorded. In the vehicle DB 48, identification information, a position, a service state, and the like of each of the plurality of the taxi vehicles VT are recorded. Moreover, in the vehicle DB 48, a position of a manual driving vehicle that is traveling in a provision area of taxi service is further recorded.

In the user DB 50, information on a user is recorded. Examples of information on a user to be recorded in the user DB 50 include identification information, a name, a contact address, and the like of the user. Moreover, among users, a user who needs to be specially carefully protected (hereinafter, referred to as a “vulnerable person”) is present. For example, an infant, a child, a pregnant woman, an elderly person, a handicapped person, and the like correspond to vulnerable persons who need to be carefully protected more than the other users. In the user DB 50, whether each user corresponds to a vulnerable person is further recorded. In addition, in the user DB 50, information on an electronic wallet to be used by the user, for example, a debit account number, a credit card number, and the like may be registered.

The management controller 40 controls allocation of the taxi vehicles VT in response to a usage demand and a protection demand transmitted by a user via the own information terminal or the user I/F 32 of the taxi vehicle VT. The usage demand is information that is transmitted when the user desires to use the taxi vehicle VT. The usage demand includes at least a destination. Moreover, when the user does not ride at a current time point but rides at a later time, the usage demand further includes a ride position and a ride date/time. The protection demand is information that is transmitted when the user requests special protection for the taxi vehicle VT in which the user is to ride, and the protection demand will be described later. In any case, the management controller 40 sets a movement position of the taxi vehicle VT in response to the usage demand and the protection demand, and transmits an allocation instruction to the taxi vehicle VT so as to move to the set movement position.

Moreover, the management controller 40 updates the vehicle DB 48 based on information that is transmitted from the taxi vehicle VT and the manual driving vehicle. Moreover, the management controller 40 also updates the user DB 50 based on registration information on the user that is transmitted from the user. Such a management controller 40 is also configured as a computer including a processor 42 and a memory 44.

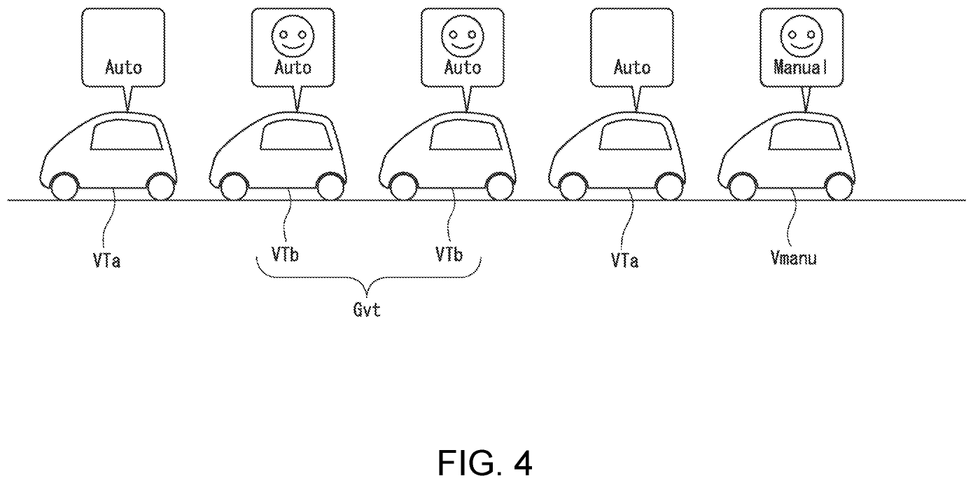

Next, protection traveling conducted in such a taxi system 10 will be described. As mentioned above, the taxi vehicle VT is a self-driving vehicle in which all the dynamic driving tasks are executed by the vehicle. The self-driving vehicle is designed so as to secure the safety of an occupant. However, even such a self-driving vehicle has difficulty in entirely preventing an accident. In particular, in an environment in which self-driving vehicles and manual driving vehicles are present in a mixed manner, it is difficult to entirely prevent an accident because the manual driving vehicle performs unexpected behavior in some cases. Therefore, in this example, even when an accident has occurred, in order to secure the safety of the user more reliably, some of the unmanned taxi vehicles VTa are caused to execute the protection traveling. FIG. 4 is an image diagram illustrating a state of the protection traveling.

In the protection traveling, the unmanned taxi vehicles VTa travel adjacently to a manned taxi group Gvt in the front-rear direction. Here, the manned taxi group Gvt is a vehicle train including one or more manned taxi vehicles VTb. When a specified protection condition is satisfied, the management center 14 instructs some of the unmanned taxi vehicles VTa to travel immediately in front of or immediately to the rear of the manned taxi group Gvt.

Here, as mentioned repeatedly, the taxi vehicle VT is a self-driving vehicle, and the inter-vehicle spacing and the speed thereof are controlled such that the safety can be assured. Therefore, normally, an accident between the taxi vehicles VT rarely occurs. However, in the surrounding of the taxi vehicle VT, many events that cannot be managed by the taxi system 10 are present. As the events that cannot be managed by the taxi system 10, there are, for example, sudden running-out by a pedestrian, unexpected behavior by another vehicle (specially, a manual driving vehicle Vmanu), generation of a road surface state (for example, freezing or a falling object) that affects traveling of the taxi vehicle VT, and the like. Due to such events that cannot be managed by the taxi system 10, there is a possibility that the taxi vehicle VT will collide with a pedestrian, another vehicle, a structural object and the like on the road (hereinafter, collectively referred to as an “obstacle”).

Meanwhile, neither a user nor a driver rides in the unmanned taxi vehicle VTa. Therefore, when the unmanned taxi vehicle VTa is broken, no human damage is generated. Therefore, in this example, when a specified protection condition is satisfied, the unmanned taxi vehicle VTa is positioned immediately to the rear or immediately in front of the manned taxi group Gvt. With such a configuration, the unmanned taxi vehicle VTa functions as a “shield” for the manned taxi group Gvt, so that the user of the manned taxi vehicle VTb can be protected safely.

For example, when the unmanned taxi vehicle VTa is traveling immediately to the rear of the manned taxi group Gvt, a case where the manual driving vehicle Vmanu that is positioned further behind has intended to bump into the rear of the manned taxi group Gvt is considered. In this case, the unmanned taxi vehicle VTa receives the energy of the rear-end collision by the manual driving vehicle Vmanu, so that the safety of the manned taxi vehicle VTb can be increased.

Moreover, when the unmanned taxi vehicle VTa is traveling immediately in front of the manned taxi group Gvt, a case where another manual driving vehicle Vmanu that is positioned further ahead has suddenly stopped is considered. In this case, there is a possibility that the brake of the unmanned taxi vehicle VTa will not act in time, and the unmanned taxi vehicle VTa bumps into the rear of the manual driving vehicle Vmanu. Meanwhile, the manned taxi vehicle VTb behind secures a sufficient inter-vehicle distance with the unmanned taxi vehicle VTa and with the manual driving vehicle Vmanu, and thus can stop appropriately without bumping into the rear of the manual driving vehicle Vmanu. As a result, the safety of the manned taxi vehicle VTb can be increased.

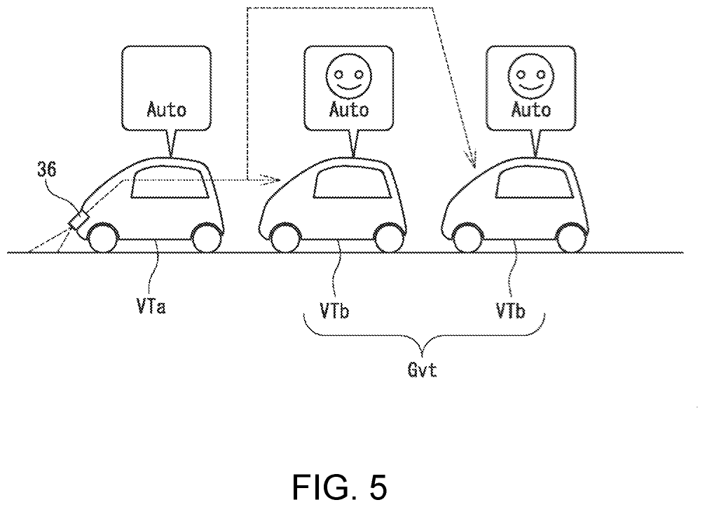

Moreover, in this example, when the unmanned taxi vehicle VTa travels immediately in front of the manned taxi group Gvt, as illustrated in FIG. 5, a detection result by the road surface sensor 36 of the unmanned taxi vehicle VTa is transmitted to one or more manned taxi vehicles VTb included in the manned taxi group Gvt. The detection result by the road surface sensor 36 includes at least one among the degree of dryness of the road surface, the presence or absence of moisture, the presence or absence of freezing, the presence or absence of slush, the presence or absence of snowfall, the presence or absence of unevenness, the presence or absence of a falling object, and the pavement type. When the manned taxi vehicle VTb has received such a detection result, the manned taxi vehicle VTb adjusts the drive control of the vehicle in accordance with the detection result. For example, when the manned taxi vehicle VTb has received the presence of a falling object as a detection result, the manned taxi vehicle VTb travels so as to avoid the falling object. Moreover, when the manned taxi vehicle VTb receives the generation of freezing on the road surface as a detection result, the manned taxi vehicle VTb adjusts the drive control such that the brake and the acceleration and deceleration are executed more slowly than at normal times. In this manner, the preceding unmanned taxi vehicle VTa transmits a road surface state to the succeeding manned taxi vehicle VTb, so that the unmanned taxi vehicle VTa functions as an “outrider” of the manned taxi vehicle VTb. This can further increase the safety and the comfortableness of the user of the manned taxi vehicle VTb.

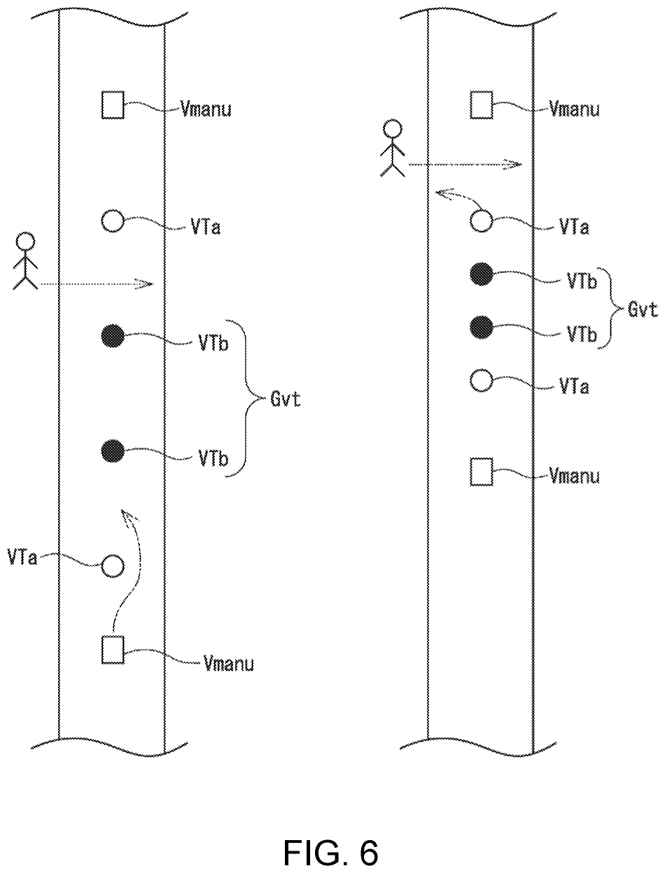

Moreover, when the protection traveling is being conducted, compared with a case where no protection traveling is conducted, the inter-vehicle distance between the taxi vehicles VT is made smaller. Moreover, the unmanned taxi vehicle VTa performs driving control that allows itself to be damaged more than the manned taxi vehicle VTb. This will be described with reference to FIG. 6. In FIG. 6, black circles indicate the manned taxi vehicles VTb included in the manned taxi group Gvt, white circles indicate the unmanned taxi vehicles VTa that protect the manned taxi group Gvt, and white rectangles indicate the manual driving vehicles Vmanu, respectively.

As illustrated at the left side in FIG. 6, when an inter-vehicle distance between the taxi vehicles VT is large, the manual driving vehicle Vmanu may cut in between the taxi vehicle VT and the taxi vehicle VT. Moreover, when the inter-vehicle distance between the taxi vehicles VT is large, a pedestrian may intend to cross the road by threading their way through between the taxi vehicle VT and the taxi vehicle VT. In other words, there is a possibility that the pedestrian will run out in front of the manned taxi vehicle VTb. In this case, the manned taxi vehicle VTb needs difficult measures in which damage to itself is avoided while securing the safety of the pedestrian.

Meanwhile, as illustrated at the right side in FIG. 6, when the inter-vehicle distance between the taxi vehicles VT is made small, the possibility that the manual driving vehicle Vmanu will cut in between the taxi vehicle VT and the taxi vehicle VT can be significantly reduced. Moreover, when the inter-vehicle distance between the taxi vehicles VT is made small, the probability that the pedestrian will cross the road not between the taxi vehicle VT and the taxi vehicle VT, but between the unmanned taxi vehicle VTa and the manual driving vehicle Vmanu with a large inter-vehicle distance, is increased. In other words, in this case, the possibility of the pedestrian suddenly running out in front of the unmanned taxi vehicle VTa is increased. At this time, the unmanned taxi vehicle VTa can take measures that protect the pedestrian although the unmanned taxi vehicle VTa itself is damaged. For example, in order to avoid the collision with the pedestrian, a measure such as changing direction significantly in a side direction can be taken. When a significant change of direction in a side direction has been made, a possibility that the unmanned taxi vehicle VTa will collide with a structural object, such as a guide rail, on the road, and be damaged, is increased, but no human damage occurs even if the unmanned taxi vehicle VTa has been damaged. In other words, with the abovementioned example, harm to both of the pedestrian and the user of the manned taxi vehicle VTb can be effectively reduced.

Next, a protection condition for determining whether the above-mentioned protection traveling is executed will be described. When a specified protection condition is satisfied, the management center 14 instructs the unmanned taxi vehicle VTa to execute the protection traveling. The protection condition is any of conditions that (1) the unmanned taxi vehicle VTa that satisfies an application possible condition is present, (2) a protection demand has been issued from the user of the manned taxi vehicle VTb, and (3) the user of the manned taxi vehicle VTb is a vulnerable person.

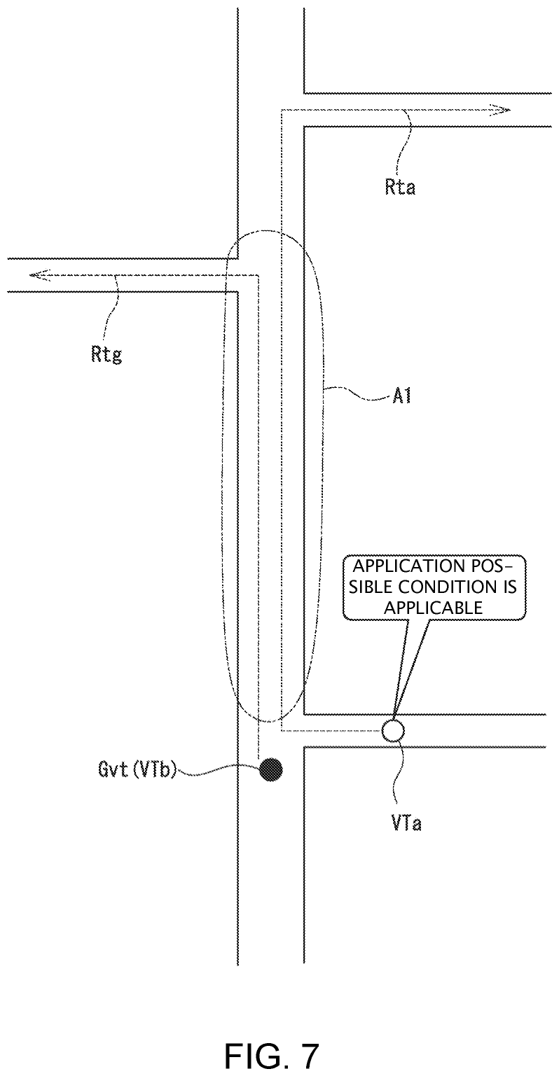

Firstly, the condition that “(1) the unmanned taxi vehicle VTa that satisfies an application possible condition is present” will be described with reference to FIG. 7. FIG. 7 is a diagram illustrating one example of traveling routes Rtg, Rta of the manned taxi group Gvt and the unmanned taxi vehicle VTa. In FIG. 7, a black circle indicates the manned taxi vehicle VTb, and a white circle indicates the unmanned taxi vehicle VTa. The “application possible condition” is a condition that allows the unmanned taxi vehicle VTa that is traveling completely independently of the manned taxi group Gvt to be applied to the protection of the manned taxi group Gvt. Specifically, the application possible condition is a condition that the unmanned taxi vehicle VTa is capable of reaching the manned taxi group Gvt within a defined protection reference time, and the traveling route Rta is at least partially overlapped with the traveling route Rtg of the manned taxi group Gvt. The protection reference time is not specially limited, and is normally about several minutes. When the unmanned taxi vehicle VTa is present at a position from which the unmanned taxi vehicle VTa cannot reach the manned taxi group Gvt within the protection reference time, the management center 14 releases the protection for the manned taxi group Gvt by the unmanned taxi vehicle VTa. Moreover, the unmanned taxi vehicle VTa for which a movement destination is set by the management center 14, even if no user rides therein, travels toward the movement destination. When the traveling route Rta of the unmanned taxi vehicle VTa does not match the traveling route Rtg of the manned taxi group Gvt, the unmanned taxi vehicle VTa and the manned taxi group Gvt cannot travel in cooperation with each other, which means that also in this case, the management center 14 releases the protection for the manned taxi group Gvt by the unmanned taxi vehicle VTa.

On the other hand, when the unmanned taxi vehicle VTa can reach the manned taxi group Gvt within the protection reference time, and the traveling route Rta of the unmanned taxi vehicle VTa and the traveling route Rtg of the manned taxi group Gvt are partially overlapped with each other, the management center 14 instructs the unmanned taxi vehicle VTa to execute the protection traveling that protects the manned taxi group Gvt. The unmanned taxi vehicle VTa having received the instruction moves immediately in front of or immediately to the rear of the manned taxi group Gvt, and travels by forming a vehicle train with the manned taxi group Gvt within a range in which the traveling routes are overlapped with each other. In the example of FIG. 7, the unmanned taxi vehicle VTa executes the protection traveling in an area A1 in which the traveling route Rta and the traveling route Rtg overlap with each other. In this manner, the unmanned taxi vehicle VTa traveling independent of the manned taxi group Gvt is applied to the protection of the manned taxi group Gvt only in the area in which the traveling routes overlap with each other, so that the safety of the manned taxi vehicle VTb can be increased without changing movement destinations of the respective taxi vehicles VT.

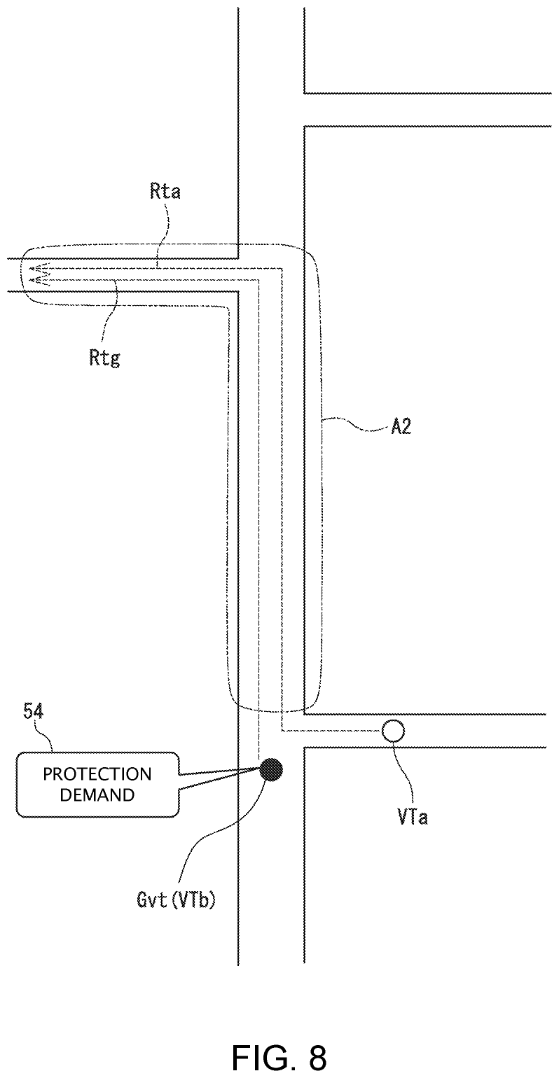

Next, the protection condition that “(2) a protection demand has been issued from the user of the manned taxi vehicle VTb” will be described with reference to FIG. 8. FIG. 8 is a diagram illustrating another example of the traveling routes Rtg, Rta of the manned taxi group Gvt and the unmanned taxi vehicle VTa. When the management center 14 has received a protection demand 54 from the manned taxi vehicle VTb, the management center 14 instructs the unmanned taxi vehicle VTa for which no task is set to execute the protection traveling. Here, the task indicates a transaction to be attained in a short period, and corresponds to the pick-up and the out-of-service. Accordingly, “the unmanned taxi vehicle VTa for which no task is set” is the unmanned taxi vehicle VTa in an empty state that is waiting until the next user appears.

Here, a movement destination of the unmanned taxi vehicle VTa during the pick-up and during the out-of-service is clearly defined even if no user rides therein, and changing the movement destination is undesirable. Meanwhile, even if a movement destination of the unmanned taxi vehicle VTa in an empty state, that has been waiting until the next user appears, has been changed, little influence occurs on a transaction in the future.

When the management center 14 has received the protection demand 54 from the user of the manned taxi vehicle VTb, after changing a movement destination of the unmanned taxi vehicle VTa so as to allow the unmanned taxi vehicle VTa in an empty state to travel together with the manned taxi vehicle VTb to the end, the management center 14 instructs the unmanned taxi vehicle VTa to execute the protection traveling. This enables the unmanned taxi vehicle VTa to execute the protection traveling in an area A2 that covers all the traveling route Rtg of the manned taxi group Gvt. Further, as a result, the safety of the user who requests the protection can be increased more reliably.

Moreover, even when no protection demand 54 from a user is present, if the management center 14 has determined that the user corresponds to a vulnerable person, in other words, an infant, a child, a pregnant woman, an elderly person, a handicapped person, or the like, the management center 14 instructs the unmanned taxi vehicle VTa for which no task is set to execute the protection traveling. Whether the user is a vulnerable person may be determined based on information recorded in the user DB 50, or whether the user is a vulnerable person may be determined based on a statement from the user. In addition, a camera for imaging a user has been mounted on the taxi vehicle VT, and whether the user is a vulnerable person may be determined by analyzing the obtained image. In any case, when the user is a vulnerable person, the execution of the protection traveling can protect the vulnerable person more reliably. Note that, when the user is a vulnerable person, similar to the case where the management center 14 has received the protection demand 54, the management center 14 sets a movement destination of the unmanned taxi vehicle VTa in an empty state to the same position as a movement destination of the manned taxi vehicle VTb in which the vulnerable person rides.

Next, determination of a traveling position of the unmanned taxi vehicle VTa when the protection traveling is started will be described. As mentioned repeatedly, during the protection traveling, the unmanned taxi vehicle VTa travels adjacently to the manned taxi group Gvt in the front-rear direction. Here, at a time before the protection traveling is started, when another unmanned taxi vehicle VTa is already present, at only one of positions immediately in front and immediately to the rear of the manned taxi group Gvt, the management center 14 instructs the unmanned taxi vehicle VTa that newly starts protection traveling to move to the other position immediately in front or immediately to the rear.

Meanwhile, at a time point when the protection traveling is started, when another unmanned taxi vehicle VTa is present neither immediately in front of nor immediately to the rear of the manned taxi group Gvt, the management center 14 selects, as a traveling position of the unmanned taxi vehicle VTa that newly starts the protection traveling, either one of positions “in immediately in front” or “immediately to the rear” of the manned taxi group Gvt. Such the selection of a traveling position may be made based on a relative positional relationship between the unmanned taxi vehicle VTa and the manned taxi group Gvt before the protection traveling is started, for example. For example, before the protection traveling is started, when the unmanned taxi vehicle VTa is positioned behind the manned taxi group Gvt, “immediately to the rear” may be selected, and when the unmanned taxi vehicle VTa is positioned ahead of the manned taxi group Gvt, “immediately in front” may be selected. With such a configuration, the number of times of passing of the taxi vehicle VT can be suppressed, so that the safety can be further increased.

Moreover, as another form, a position of the unmanned taxi vehicle VTa that newly starts protection traveling may be selected based on the presence or absence of a manual driving vehicle that travels adjacently to the manned taxi group Gvt in the front-rear direction before the protection traveling is started. For example, when a manual driving vehicle adjacent to the manned taxi group Gvt in the front-rear direction is present, the management center 14 may determine a position of the unmanned taxi vehicle VTa such that the unmanned taxi vehicle VTa cuts in between the manual driving vehicle and the manned taxi group Gvt. With such a configuration, the safety of the manned taxi vehicle VTb included in the manned taxi group Gvt can be further increased. In other words, a driver conducts a driving operation of the manual driving vehicle, so that the manual driving vehicle may perform unexpected behavior due to a human error and the like in some cases. The unmanned taxi vehicle VTa is caused to cut in between such a manual driving vehicle and the manned taxi group Gvt, whereby the manned taxi vehicle VTb can be appropriately protected from the manual driving vehicle.

Moreover, as still another form, a traveling position of the unmanned taxi vehicle VTa may be determined based on a position of the manned taxi vehicle VTb in which a vulnerable person rides, within the manned taxi group Gvt. For example, when the manned taxi vehicle VTb in which a vulnerable person rides travels at the forefront of the manned taxi group Gvt, as a traveling position of the unmanned taxi vehicle VTa, “immediately in front” of the manned taxi group Gvt (eventually, immediately in front of the manned taxi vehicle VTb in which the vulnerable person rides) may be selected. Similarly, when the manned taxi vehicle VTb in which a vulnerable person rides travels at the tail end of the manned taxi group Gvt, as a traveling position of the unmanned taxi vehicle VTa, “immediately to the rear” of the manned taxi group Gvt (eventually, immediately to the rear of the manned taxi vehicle VTb in which a vulnerable person rides) may be selected. With such a configuration, the vulnerable person can be protected more reliably.

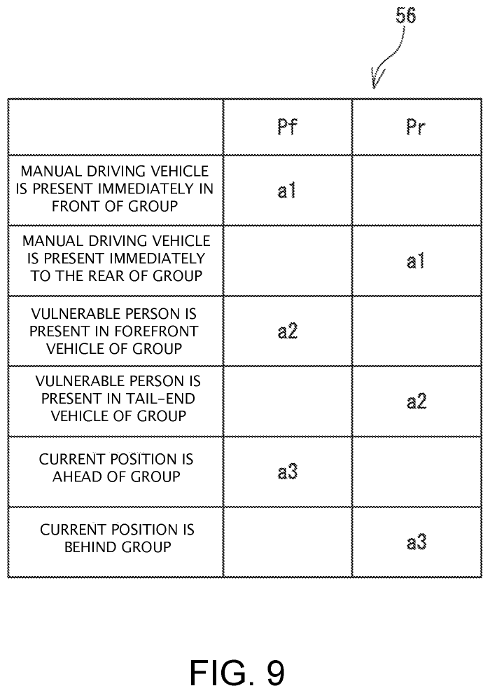

In addition, as still another form, based on the condition as mentioned above, scores Pf, Pr are respectively calculated with respect to each of “immediately in front” and “immediately to the rear”, and a traveling position of the unmanned taxi vehicle VTa may be determined based on a magnitude relationship between the two scores Pf, Pr. This will be described with reference to FIG. 9. FIG. 9 is a diagram illustrating one example of a score table 56 that is referred to when the scores Pf, Pr are calculated. In FIG. 9, a1 to a3 represent specified numerical values, respectively. Conditions to be considered when a score is calculated are recorded in the first row of the score table 56, and values to be added respectively to the immediately in front score Pf and the immediately to the rear score Pr when a corresponding condition is satisfied are recorded in the second row and the third row. Accordingly, for example, when a manual driving vehicle is present immediately in front of the manned taxi group Gvt, a numerical value a1 is added to the immediately in front score Pf. Similarly, when a manual driving vehicle is present immediately to the rear of the manned taxi group Gvt, the numerical value a1 is added to the immediately to the rear score Pr. In addition, when a vulnerable person rides in a foremost vehicle of the manned taxi group Gvt, a numerical value a2 is added to the immediately in front score Pf. Hereinafter, similarly, when a condition in the first row is satisfied, a corresponding numerical value is added to a corresponding score. The management center 14 compares the immediately in front score Pf and the immediately to the rear score Pr eventually obtained with each other. Further, as a traveling position of the unmanned taxi vehicle VTa, when Pf≥Pr, “immediately in front” of the manned taxi group Gvt is selected, and when Pf<Pr, “immediately to the rear” is selected.

In this manner, immediately in front and immediately to the rear scores are respectively calculated, whereby the unmanned taxi vehicle VTa can be arranged at a more suitable position, and the manned taxi group Gvt can be protected more efficiently. Note that the management center 14 or the unmanned taxi vehicle VTa may conduct the calculation and the comparison of the above-mentioned scores Pf, Pr. When the unmanned taxi vehicle VTa calculates the scores Pf, Pr, the unmanned taxi vehicle VTa acquires position information on the manned taxi group Gvt and the manual driving vehicle Vmanu, and information on the presence or absence of a vulnerable person, for example, from the management center 14.

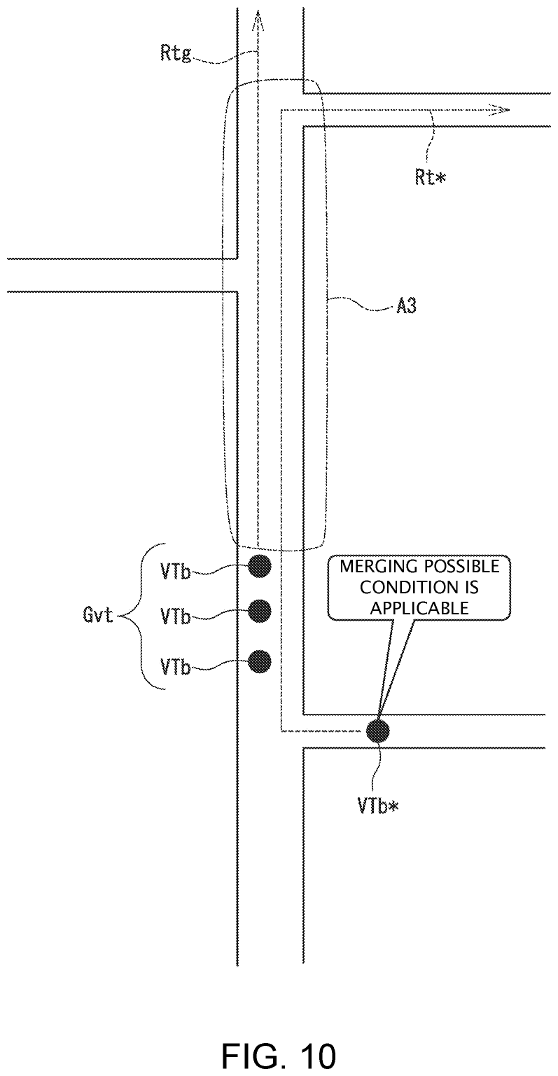

Next, forming the manned taxi group Gvt will be described with reference to FIG. 10. FIG. 10 is an image diagram illustrating a state where the manned taxi group Gvt is formed. As mentioned repeatedly, the taxi vehicle VT is a self-driving vehicle. In this case, one of the taxi vehicles VT easily predicts behaviors of the other taxi vehicles VT, and an accident rarely occurs with the other taxi vehicles VT. Meanwhile, it is difficult for the taxi vehicle VT to accurately predict behavior of a different vehicle that does not belong to the taxi system 10. Therefore, the safety of the manned taxi vehicle VTb is secured easier when the manned taxi vehicle VTb is more adjacent to the taxi vehicle VT than to the different vehicle.

In other words, as many manned taxi vehicles VTb as possible are gathered so as to be adjacent to each other to increase the safety. Moreover, the manned taxi vehicles VTb are positively gathered, so that the number of the manned taxi groups Gvt in the whole taxi system 10 can be suppressed to a small number, and the number of the unmanned taxi vehicles VTa that protect the manned taxi group Gvt can also be suppressed to the small number.

Therefore, in this example, the manned taxi vehicle VTb is configured to merge with the near manned taxi group Gvt. Specifically, when a defined merging possible condition is satisfied between the manned taxi group Gvt and a different manned taxi vehicle VTb* that does not belong to the manned taxi group Gvt, the management center 14 instructs the manned taxi group Gvt and the different manned taxi vehicle VTb* to merge with each other.

Here, the merging possible condition is a condition that the manned taxi group Gvt and the different manned taxi vehicle VTb* can be merged with each other within a prescribed merge time, and a traveling route Rt* of the different manned taxi vehicle VTb* is partially overlapped with the traveling route Rtg of the manned taxi group Gvt. In the example of FIG. 10, the merging possible condition is satisfied by the different manned taxi vehicle VTb* relative to the manned taxi group Gvt. In this case, the management center 14 instructs the different manned taxi vehicle VTb* to merge with the manned taxi group Gvt. The different manned taxi vehicle VTb* having received such an instruction temporarily accelerates to merge with the manned taxi group Gvt. Moreover, in the example of FIG. 10, the traveling route Rt* matches the traveling route Rtg only in the range of an area A3. Therefore, the different manned taxi vehicle VTb* merges with the manned taxi group Gvt only in the range of the area A3, and leaves the manned taxi group Gvt when coming out from the area A3.

Note that the manned taxi vehicle VTb travels toward a destination in accordance with an instruction from a user. In this case, in order for the different manned taxi vehicle VTb* and the manned taxi group Gvt to merge with each other, extending the required time for reaching the destination of each of the manned taxi vehicles VTb, VTb* does not match the desire of the user in many cases. Therefore, either one of the different manned taxi vehicle VTb* and the manned taxi group Gvt may accelerate, thereby merging with each other. For example, when the different manned taxi vehicle VTb* travels ahead of the manned taxi group Gvt, the different manned taxi vehicle VTb* neither decelerates nor stops, but the manned taxi group Gvt may accelerate to reach the manned taxi vehicle VTb*. In any case, as many manned taxi vehicles VTb as possible are gathered to form the manned taxi group Gvt, whereby a greater number of the manned taxi vehicles VTb can be more efficiently protected.

Moreover, any of the configurations having been described are merely examples, and when at least the prescribed protection condition is satisfied, the other configurations may be changed as long as the unmanned taxi vehicle VTa travels adjacently to the manned taxi group Gvt. For example, the unmanned taxi vehicle VTa may travel adjacently to the manned taxi group Gvt not only in the front-rear direction but in a left-right direction. For example, when the taxi vehicles VT travels on a road having a plurality of lanes in which the taxi vehicles VT can travel side by side in the left-right direction, the unmanned taxi vehicle VTa may travel adjacently to the manned taxi group Gvt in the left-right direction in order to protect the manned taxi group Gvt.

Moreover, in the abovementioned description, as the protection condition, the three conditions that (1) the application possible condition is satisfied, (2) the protection demand 54 has been issued from the user, and (3) the vulnerable person rides, have been provided, but the protection condition may be changed as appropriate. For example, any one or two of the abovementioned (1) to (3) may be removed from the protection condition. Moreover, another condition may be added as the protection condition.

Moreover, the behaviors (for example, an inter-vehicle distance and the like) of the manned taxi vehicle VTb and the unmanned taxi vehicle VTa when the protection traveling is executed are not limited to the abovementioned description, but may be changed as appropriate. Moreover, in the description in the foregoing, the taxi vehicle VT is a single-passenger vehicle, but the taxi vehicle VT may be a multi-passenger vehicle in which a plurality of persons can ride.

### REFERENCE SIGNS LIST

10 taxi system, 14 management center, 20 vehicle controller, 22, 42 processor, 24, 44 memory, 26 drive unit, 28 vehicle sensor group, 30, 46 communication I/F, 32 user I/F, 34 payment device, 36 road surface sensor, 40 management controller, 48 vehicle DB, 50 user DB, 54 protection demand, 56 score table, Gvt manned taxi group, VT taxi vehicle, VTa unmanned taxi vehicle, VTb, VTb* manned taxi vehicle, Vmanu manual driving vehicle.

1. A taxi system comprising:
a plurality of taxi vehicles that each transport a user to a destination in a state where no driver rides therein, by automatic driving; and
a management device that manages the plurality of the taxi vehicles, wherein
the management device divides and manages the plurality of the taxi vehicles into one or more manned taxi vehicles in which the user rides and one or more unmanned taxi vehicles in which the user does not ride,
the management device, when a prescribed protection condition is satisfied, instructs the one or more unmanned taxi vehicles to execute protection traveling that is traveling while protecting a manned taxi group including the one or more manned taxi vehicles, and
the unmanned taxi vehicle, when having received an execution instruction of the protection traveling, protects the manned taxi group by traveling adjacently to the manned taxi group in a front-rear direction or in a left-right direction.

2. The taxi system according to claim 1, wherein
the protection condition includes the unmanned taxi vehicle being present that satisfies an application possible condition in which the unmanned taxi vehicle is capable of reaching the manned taxi group within a defined protection reference time, and a traveling route of the unmanned taxi vehicle is at least partially overlapped with that of the manned taxi group, and
the management device, when the unmanned taxi vehicle that satisfies the application possible condition is present, instructs the unmanned taxi vehicle to execute the protection traveling.

3. The taxi system according to claim 1, wherein
the protection condition includes a protection demand having been issued from a user of the manned taxi vehicle, and
the management device, when having received the protection demand, instructs an unmanned taxi vehicle for which no task is set to execute the protection traveling.

4. The taxi system according to claim 1, wherein
the protection condition includes a vulnerable person riding in the manned taxi vehicle, and
the management device, when the manned taxi vehicle in which the vulnerable person is riding is present, instructs the unmanned taxi vehicle for which no task is set to conduct the protection traveling.

5. The taxi system according to claim 1, wherein
the taxi vehicle includes a road surface sensor that detects a road surface state, and
the unmanned taxi vehicle, when traveling immediately in front of the manned taxi group for the protection traveling, transmits a detection result by the road surface sensor to the manned taxi group to be protected.

6. The taxi system according to claim 1, wherein the management device determines a traveling position of the unmanned taxi vehicle when the protection traveling is executed, based on at least one among a relative positional relationship between the unmanned taxi vehicle and the manned taxi group before the protection traveling is started, presence or absence of a manual driving vehicle that travels adjacently to the manned taxi group in the front-rear direction before the protection traveling is started, and a position of the manned taxi vehicle in which a vulnerable person rides in the manned taxi group.

7. The taxi system according to claim 1, wherein the management device, when the manned taxi group and a different manned taxi vehicle that does not belong to the manned taxi group are capable of merging with each other within a defined merge reference time, and a traveling route of the manned taxi group and a traveling route of the different manned taxi vehicle are at least partially overlapped with each other, instructs the manned taxi group and the different manned taxi vehicle to merge with each other.

8. The taxi system according to claim 1, wherein
the management device manages respective traveling positions of the manned taxi vehicle, the unmanned taxi vehicle, and the manual driving vehicle in which a driver conducts a driving operation, and
the management device, when the manual driving vehicle and the manned taxi group are adjacent to each other in the front-rear direction, selects with priority a position between the manual driving vehicle and the manned taxi group as a traveling position of the unmanned taxi vehicle that protects the manned taxi group.
